(19) United States
(12) Patent Application Publication
(10) Pub. No.: US 2005/0087536 A1
(43) Pub. Date: Apr. 28, 2005

(54) Aluminum cylinder with a plastic coating

(76) Inventors: Ronald Caudill, Santa Ana, CA (US); Robert Beck, Victorville, CA (US); Gary Newman, Upland, CA (US); Honorio Lim, West Covina, CA (US)

Correspondence Address: David C. Jenkins;Eckert Seamans Cherin & Mellott, LLC, 600 Grant Street, 44th Floor, Pittsburgh, PA, 15219, US

(21) Appl. No.: 10/692,116

(22) Filed: Oct. 23, 2003

(51) Int. Cl. F17C 1/00

(52) U.S. Cl. 220/586

(57) ABSTRACT

A gas cylinder having an aluminum shell, a composite wrap, and a plastic coating. The aluminum shell has an outer side and an inner side defining a storage space. The composite wrap is disposed about the aluminum shell. The plastic coating is disposed on the cylinder inner side.

### BACKGROUND OF THE INVENTION

1. Field of the Invention

This invention relates to high pressure gas cylinders and, more specifically, to aluminum cylinders having a plastic interior coating.

2. Background Information

Cylinders used for high pressure gas storage commonly are typically one of three varieties: all metal (commonly steel), a metal shell over-wrapped with composite materials, or a plastic shell over-wrapped with composite materials. Each type cylinder will have “fill-use” cycle lives of 8,000-10,000 cycles—before ending their useful life. Each type of cylinder has advantages and disadvantages. For example, a steel cylinder is strong but heavy; a composite/aluminum cylinder is light, but typically has a limited fill-use cycle; and a composite/plastic cylinder is light but is weak and prone to damage.

There have been two general combinations of these technologies. Steel cylinders have been wrapped with composite materials to allow thinner, lighter shells while maintaining their strength. Additionally, steel cylinders have included independent plastic linings to prevent reaction with stored fluids. However, because composite/aluminum cylinders and composite/plastic cylinders shared the advantage of being light, while generally being more inert than steel, there has not been a need to combine these two technologies.

### SUMMARY OF THE INVENTION

It has been determined that when an composite/aluminum cylinder is combined with a plastic coating, the total weight of the cylinder is reduced, compared with the all metal cylinders, and the cycle life is significantly extended over that achievable by the base designs. More specifically, it has been found that use of the plastic coating on a composite/aluminum cylinder increases the cycle life of a cylinder between about 50% to 150%.

The aluminum/composite/plastic cylinder is a light weight, thin walled cylinder containing an interior plastic coating that is heat-bonded to the aluminum. The aluminum liner is surrounded by a composite outer wrap, typically carbon or aramid and fiberglass filaments held within an epoxy resin matrix. The cylinder is designed to contain gas ranging in pressure from 500 to 10,000 psi. The cylinders typically range in volume from 0.5 to 500 liters. Such cylinders are especially adapted to be used as a self-contained breathing apparatus, a home oxygen therapy cylinder, a commercial aviation cylinder, a fuel storage cylinder in natural gas and hydrogen vehicles, and with military and aerospace applications.

### BRIEF DESCRIPTION OF THE DRAWINGS

A full understanding of the invention can be gained from the following description of the preferred embodiments when read in conjunction with the accompanying drawings in which:

FIG. 1 is a side view of a cylinder assembly.

FIG. 2 is a partial cutaway view of the cylinder shown in FIG. 1.

### DESCRIPTION OF THE PREFERRED EMBODIMENTS

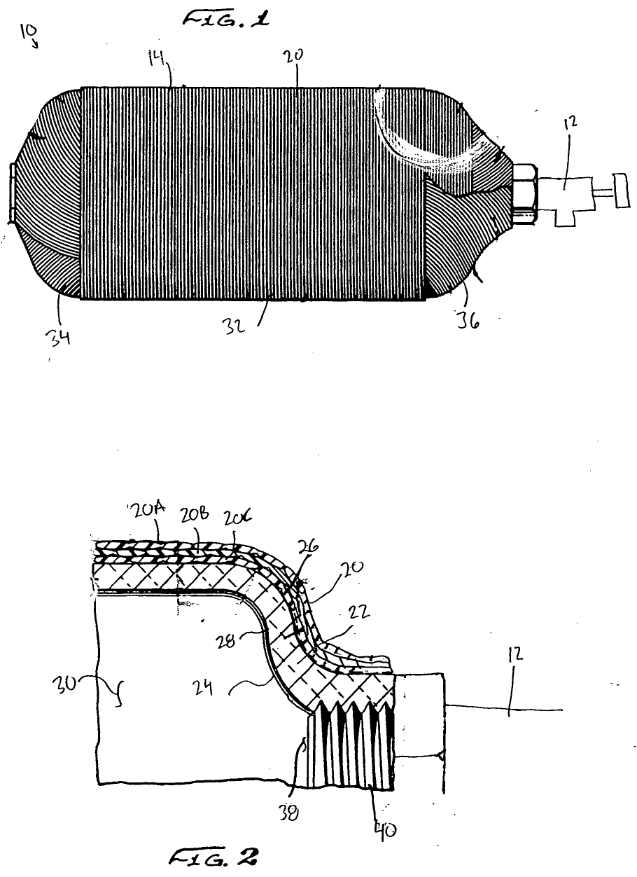

As shown in FIG. 1, a cylinder assembly 10 includes a valve assembly 12 and a high pressure gas cylinder 14. The valve assembly 12 may be any type of valve assembly 12 known in the art. The valve assembly 12 is structured to sealingly engage the gas cylinder 14 and is further structured to move between a closed position, wherein fluid may not pass through the valve assembly 12, and an open position, wherein fluid may pass through the valve assembly 12. The gas cylinder 14, as shown in FIG. 2, includes an outer composite wrap 20, an aluminum shell 22, and a plastic coating 24. The aluminum shell 22 has an outer side 26 and an inner side 28. The inner side 28 defines a storage space 30. The aluminum shell 22 is, preferably, an elongated cylinder 32 having a dome 34, 36 at each end (FIG. 1). The storage space 30 preferably holds between about 0.5 to 500 liters of fluid. One dome 36 includes a neck passage 38 through which fluid may pass to and from the storage space 30. The aluminum shell 22 at the neck passage 38 may have threads 40 structured to engage the valve assembly 12 or a plug (not shown).

The composite wrap 20 is disposed on the cylinder outer side 26. The composite wrap 20 includes a filament material and an epoxy resin. Preferably the composite wrap 20 includes carbon or aramid and fiberglass material. The composite wrap 20, preferably, covers the entire cylinder outer side 26. The composite wrap 20 may include multiple layers 20A, 20B, 20C applied over the cylinder outer side 26.

The plastic coating 24 is applied to the cylinder inner side 28 and is, preferably, adhered by heat bonding. The plastic coating 24 is, preferably, a polyethylene copolymer such as polyolefin resin and olefinic polymer blends.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

1. A gas cylinder comprising:
an aluminum shell having an outer side and an inner side defining a storage space;
a composite wrap disposed about said aluminum shell; and
a plastic coating disposed on said inner side.

2. The gas cylinder of claim 1, wherein said plastic coating is heat bonded to said inner side.

3. The gas cylinder of claim 2, wherein said plastic coating is a polyethylene copolymer.

4. The gas cylinder of claim 3, wherein said storage space is between about 0.5 and 500 liters.

5. The gas cylinder of claim 4, wherein said composite wrap is carbon or aramid and fiberglass.

6. The gas cylinder of claim 1, wherein said storage space is between about 0.5 and 500 liters.

7. The gas cylinder of claim 1, wherein said composite wrap is carbon or aramid and fiberglass.

8. A cylinder assembly comprising:
a valve assembly structured to sealingly engage a cylinder; and
a cylinder comprising:
an aluminum shell having an outer side and an inner side defining a storage space;
a composite wrap disposed about said aluminum shell; and
a plastic coating disposed on said inner side.

9. The cylinder assembly of claim 8, wherein said plastic coating is heat bonded to said inner side.

10. The cylinder assembly of claim 9, wherein said plastic coating is a polyethylene copolymer.

11. The cylinder assembly of claim 10, wherein said storage space is between about 0.5 and 500 liters.

12. The cylinder assembly of claim 11, wherein said composite wrap is carbon or aramid and fiberglass.

13. The cylinder assembly of claim 12, wherein said cylinder is structured to contain a gas at a pressure between about 500 to 10,000 psi.

14. The cylinder assembly of claim 8, wherein said storage space is between about 0.5 and 500 liters.

15. The cylinder assembly of claim 8, wherein said composite wrap is carbon or aramid and fiberglass.

16. The cylinder assembly of claim 8, wherein said cylinder is structured to contain a gas at a pressure between about 500 to 10,000 psi.
